(19) United States
(12) Patent Application Publication
(10) Pub. No.: US 2009/0064733 A1
(43) Pub. Date: Mar. 12, 2009

(54) Lock core

(75) Inventor: Pi-Chiu Liu, Tainan City (TW)

Correspondence Address: Pi-Chiu LIU, P.O. Box 90, Tainan City, 70499, TW

(73) Assignees: Pi-Chiu LIU; Jiun-Ming-LI

(21) Appl. No.: 11/898,086

(22) Filed: Sep. 10, 2007

(51) Int. Cl. E05B 67/06

(52) U.S. Cl. 70/35

(57) ABSTRACT

A lock core includes a lock core base, a button, a cover, a connecting member, a bayonet base, a bayonet and two compression springs. It can be applied in diverse locks, such as a transmission lock, a door lock or a safe deposit lock etc, able to achieve an excellent anti-theft effect because it is installed invisibly, locked by just pressing a button and opened without a key and with a remote controller.

### BACKGROUND OF THE INVENTION

1. Field of the Invention

This invention relates to a lock core, particularly to one installed invisibly in all kinds of locks with an excellent anti-theft effect.

2. Description of the Prior Art

Commonly, a conventional lock core is provided with a keyhole for a key to insert to lock or unlock the lock core. The lock core is provided with plural bayonets extended in the keyhole with diverse lengths, which are exactly engaged with grooves shaped around the key, so that the bayonets can push the lock core to rotate when the key is inserted and rotated in the keyhole, keeping other linked transmitting mechanisms moved to lock or unlock the lock core. But, such a lock core is actually not difficult to be unlocked by inserting an alternative pin, instead of the key, to push the bayonets. So, it is not a safe anti-theft lock.

### SUMMARY OF THE INVENTION

The objective of this invention is to offer a lock core installed invisibly in a lock.

The main characteristics of the invention are a lock core base, a button, a cover, a connecting member, a bayonet base, a bayonet and two compression springs. The lock core base is provided with a chamber, a through hole bored in its one end to communicate with the chamber, an annular blocking surface formed at the boundary between the chamber and the through hole, and a threaded hole bored in its annular wall to communicate with the chamber. The button set in the lock core base is provided with a locking groove and a dead bolt member extended out from its one end. One of the compression springs is mounted around the dead bolt member, installed in the chamber. The cover installed at one end of the lock core base is provided with a through hole for the dead bolt member of the button to pass through. The connecting member is installed in the annular wall of the lock core base, provided with a through hole. The bayonet base connected with the connecting member is provided with a chamber and a through hole bored in its one end to communicate with the chamber. The bayonet inserted in the bayonet base is provided with a blocking flange and a connecting rod extended out from the blocking rim. The other compression spring is mounted around the connecting rod of the bayonet, installed in the chamber of the bayonet base.

### BRIEF DESCRIPTION OF DRAWINGS

This invention is better understood by referring to the accompanying drawings, wherein:

FIG. 1 is an exploded perspective view of a preferred embodiment of a lock core in the present invention;

FIG. 2 is a perspective view of the preferred embodiment of a lock core in the present invention;

FIG. 3 is a cross-sectional view of the preferred embodiment of a lock core in the present invention;

FIG. 4 is a perspective view of a transmission, showing it being installed with the preferred embodiment of the present invention;

FIG. 5 is a cross-sectional view of the transmission installed with the preferred embodiment of the present invention, showing it being unlocked by the invention;

FIG. 6 is a cross-sectional view of the transmission installed with the preferred embodiment of the present invention, showing it being locked by the invention;

FIG. 7 is a perspective view of a door lock, showing it being installed with the preferred embodiment of the present invention;

FIG. 8 is a cross-sectional view of the door lock installed with the preferred embodiment of the present invention, showing it being unlocked by the invention;

FIG. 9 is a cross-sectional view of the door lock installed with the preferred embodiment of the present invention, showing it being locked by the invention; and

FIG. 10 is a perspective view of a safe deposit lock, showing it being installed with the preferred embodiment of present invention.

### DETAILED DESCRIPTION OF THE PREFERRED EMBODIMENT

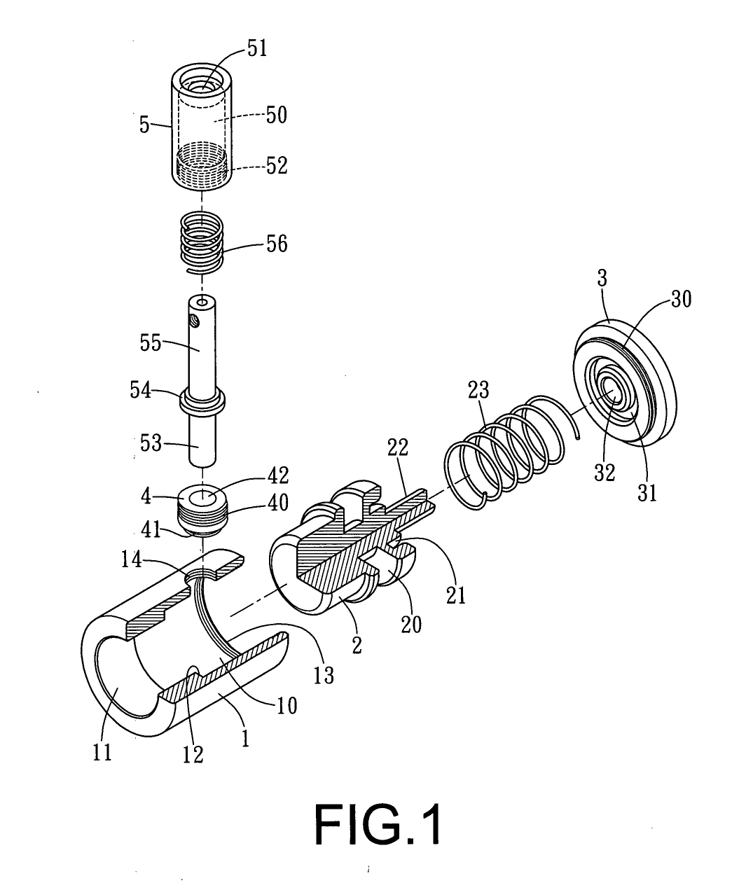

As shown in FIG. 1, a preferred embodiment of a lock core in the present invention is composed of a lock core base 1, a button 2, a cover 3, a connecting member 4, a bayonet base 5, a bayonet 53 and two compression springs 23 and 56.

The lock core base 1 is provided with a chamber 10, a through hole 11 bored in its one end to communicate with the chamber 10, an annular blocking surface 12 formed at the boundary between the chamber 10 and the through hole 11, female threads 13 formed at the other end of the chamber 10, and a threaded hole 14 bored in its annular wall to communicate with the chamber 10.

The button 2 is set in the lock core base 1, provided with a locking groove 20, an annular slot 21 formed in its one side, a dead bolt member 22 extended out from the annular slot 21. The compression spring 23 is mounted around the dead bolt member 22, installed in the chamber 10.

The cover 3 installed at one end of the lock core base 1 is provided with male threads 30, an annular slot 31 formed at its one side, and a through hole 32 bored in its center.

The connecting member 4 is installed in the annular wall of the lock core base 1, provided with upper male threads 40, lower male threads 41 and a through hole 42 opened through its center.

The bayonet base 5 connected with the connecting member 4 is provided with a chamber 50, a through hole 51 bored in its one end to communicate with the chamber 50, and female threads 52 formed at the other end. The bayonet 53 inserted in the chamber 50 is provided with a blocking flange 54 located near its intermediate portion, a connecting rod 55 extended out from the blocking flange 54. The compression spring 56 is mounted around the bayonet 53, installed in the chamber 50.

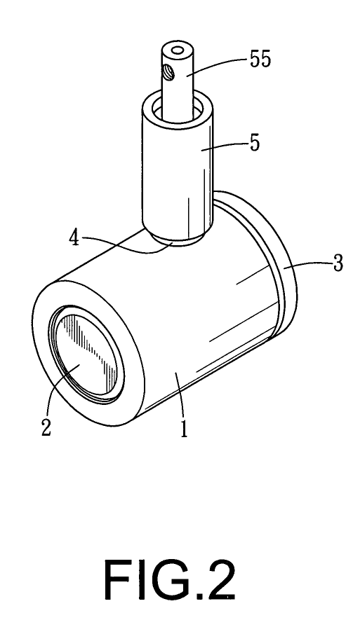

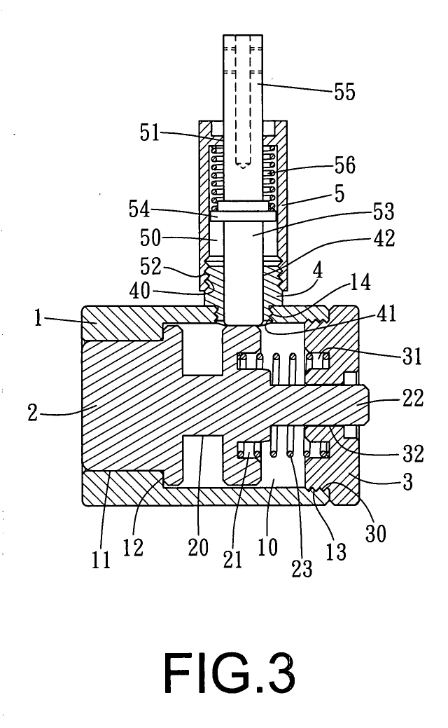

In assembly, as shown in FIGS. 1-3, the button 2 is first installed in the chamber 10 of the lock core base 1, keeping its one end fitted in the through hole 11 of the lock core base 1. Next, put the compression spring 23 on the dead bolt 22, keeping one end of the compression spring 23 fitted in the annular slot 21. The cover 3 is successively put on the compression spring 23 to keep the male threads 30 screwed with the female threads 13 of the lock core base 1, so that the cover 3 is fixed together with one side of the lock core base 1, enabling the dead bolt member 22 of the button 2 installed in the chamber 10 to extend out through the through hole 32 of the cover 3, and the other end of the compression spring 23 is to be fitted in the annular slot 31 of the cover 3. By the time, the button 2 is pushed by the compression spring 23 to keep its end surface positioned in a same plane of the end of the lock core base 1. Then, the connecting member 4 is connected with the lock core base 1 via screwing the lower male threads 41 in the threaded hole 14 of the lock core base 1. The compression spring 56 is mounted around the connecting rod 55. Next, put the bayonet 53, the connecting rod 55 and the compression spring 56 into the chamber 50 of the bayonet base 5, keeping the connecting rod 55 extended out through the through hole 51 of the bayonet base 5 and the female threads 52 screwed with the upper male threads 40 of the connecting member 4, so that the bayonet base 5 is fixed with the connecting member 4. By the time, the bayonet 53 is inserted through the through hole 42 of the connecting member 4. That is a complete assembly of the lock core.

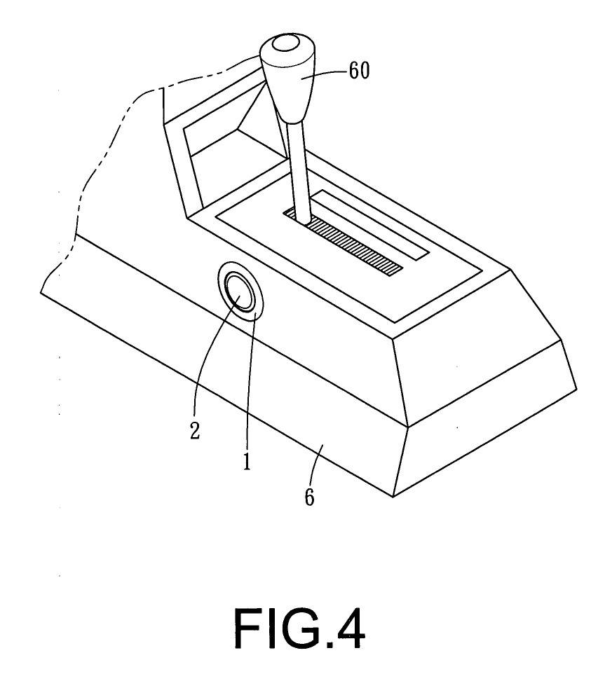

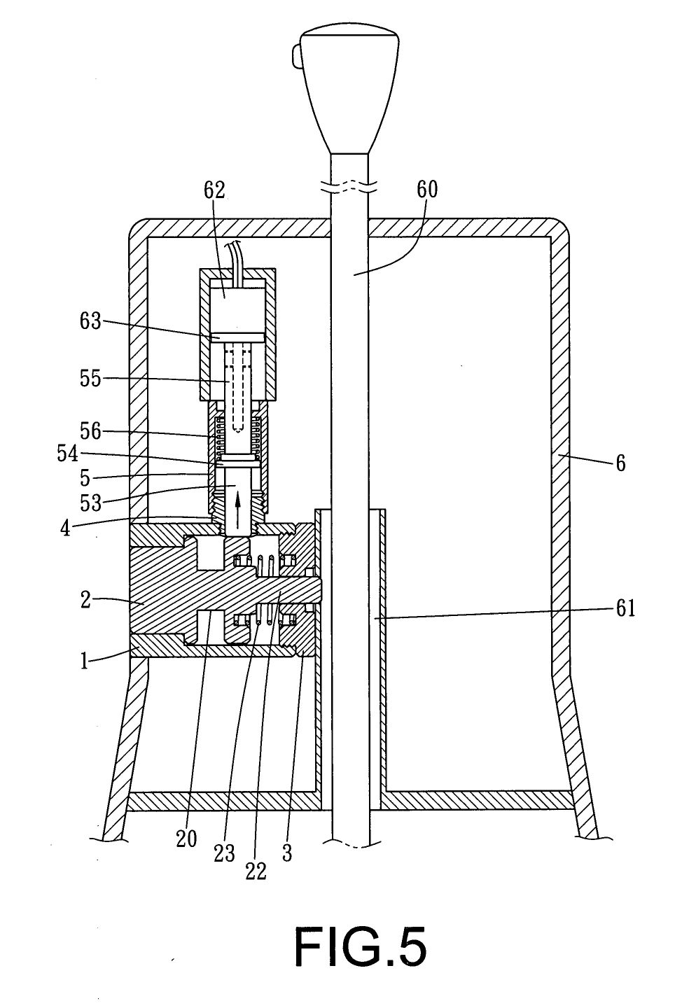

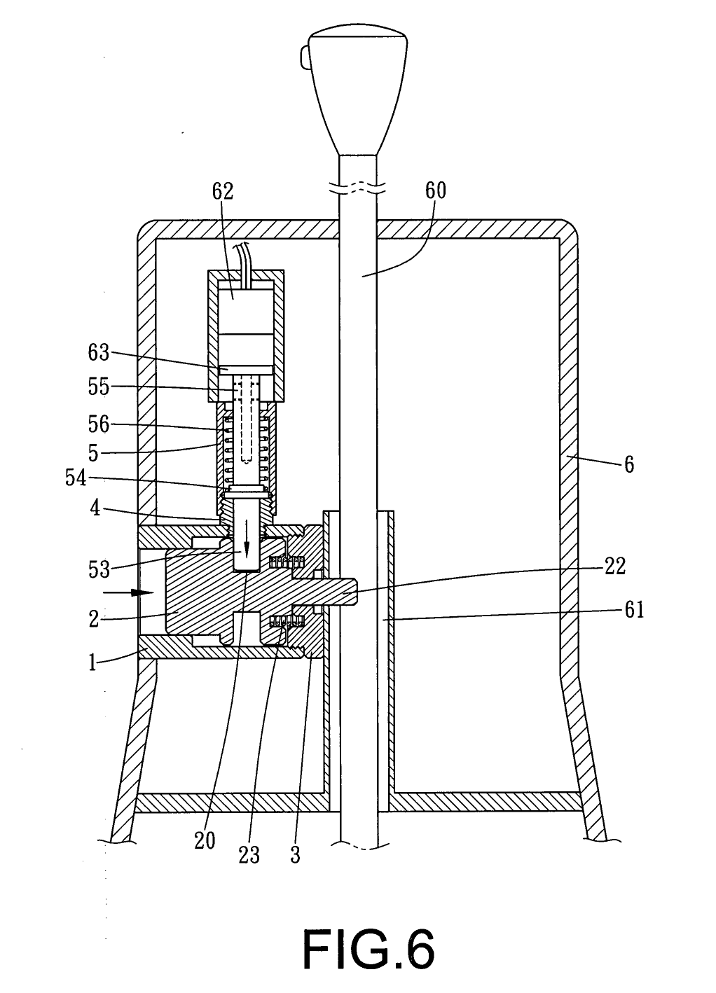

In application, as shown in FIGS. 4 - 6, the invention can be employed to lock or unlock a transmission 6. When transmission 6 is to be locked, a user needs just to press the button 2 to keep the dead bolt member 22 moved into a passageway 61 of the transmission 6. By the time, the compression spring 23 is compressed and the locking groove 20 is moved to a position exactly corresponding to the bayonet 53, which is synchronously forced by the elasticity of the compression spring 56 to move into the locking groove 20, keeping the button 2 positioned and the dead bolt member 22 extended into the passageway 61 to restrict a gear lever 60 of the transmission 6 from moving away from the parking gear, as shown in FIG. 6. Therefore, the transmission 6 is locked, unable to be operated. When the transmission 6 is to be unlocked, a user can use a remote controller to enable an electric magnet 62 in the transmission 6 magnetized to attract a magnetic plate 63 connected with the end of the connecting rod 55, as shown in FIG. 5. While the magnetic plate 63 is being attracted by the electric magnet 62, the bayonet 53 is to be synchronously moved to come off the locking groove 20. The compression spring 23 in the chamber 10 of the lock core base 1 is to elastically push the 2 out as soon as the bayonet 53 moves away the locking groove 20 completely, spontaneously enabling the dead bolt member 22 to move away from the passageway 61 of the transmission 6, keeping the gear lever 60 unrestricted. So, the transmission 6 can be operated again. With the lock core of the invention hidden in the transmission 6 and unlocked without a key, a thief cannot easily break it.

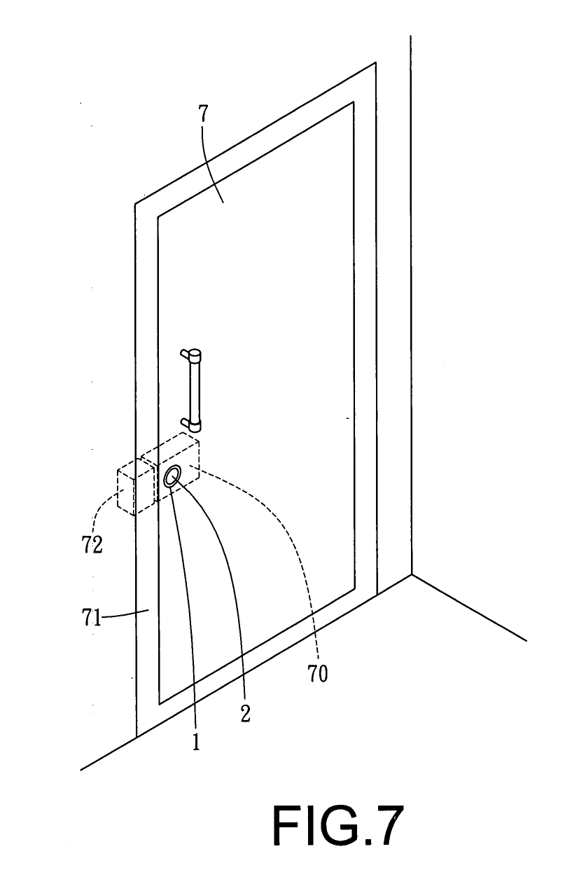

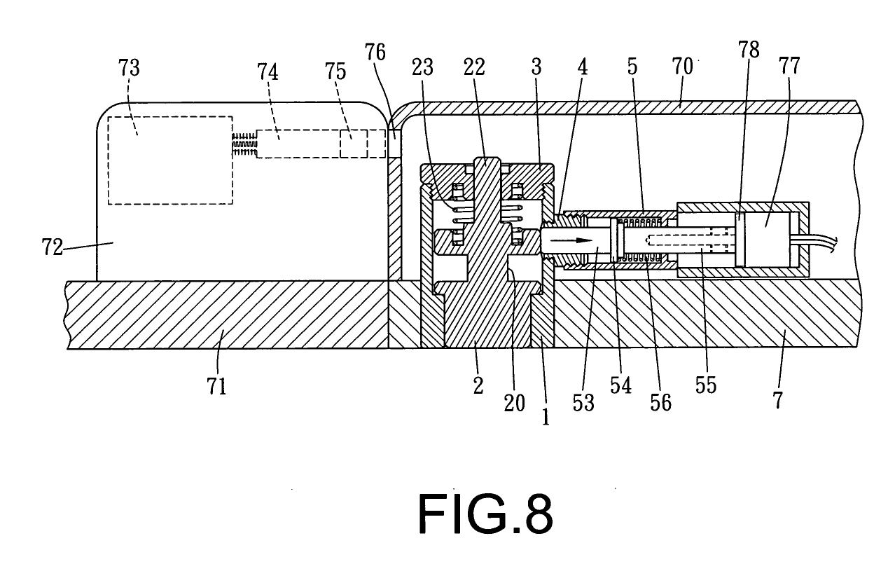

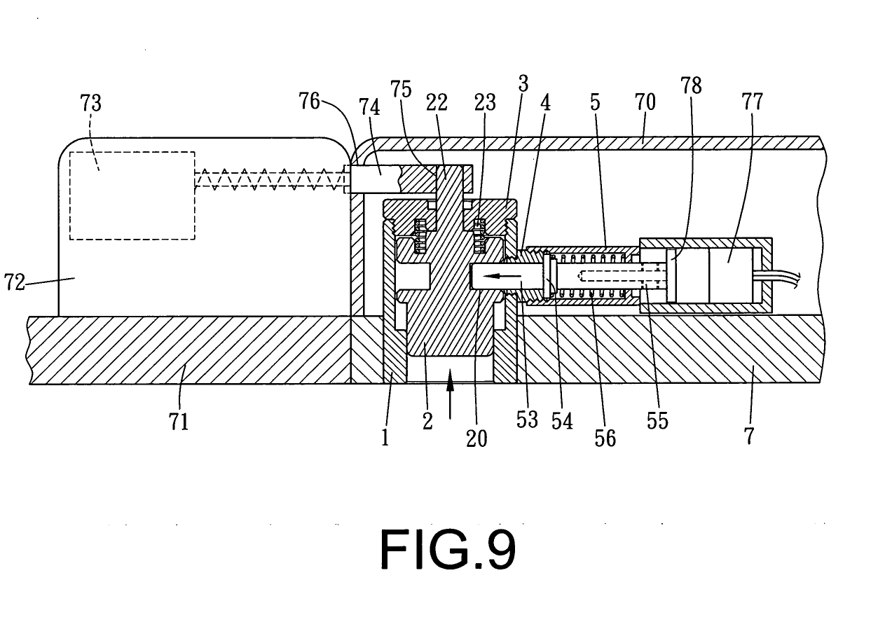

As shown in FIGS. 7-9, the invention can be also applied in a door lock 70 installed in a door 7. A control box 72 is set on the inside of a door frame 71 to face exactly to the door lock 70, installed with a mechanism 73 inside it to drive a dead bolt 74 to act. The dead bolt 74 is bored with a hole 75. In using, a remote controller is used to control the control mechanism 73 in the control box 72 to push the dead bolt 74 outward to pass into the door lock through an opening 76, keeping the hole 75 positioned to face to the dead bolt member 22 rightly. Next, press the button 2 to enter the hole 75 of the locking bolt 74, as shown in FIG. 9. By the time, the compression spring 23 is compressed and the locking groove 20 is moved inward to a position exactly corresponding to the bayonet 53, which is synchronously forced by the elasticity of the compression spring 56 to move into the locking groove 20, keeping the button 2 positioned and the dead bolt member 22 extended into the hole 75 of the dead bolt 74 to keep the dead bolt 74 restricted immovably. So, the door 7 is locked unable to be opened. When the door lock 70 is to be unlocked, a user can also use a remote controller to enable an electric magnet 77 in the door lock 70 magnetized to attract a magnetic plate 78 connected with the end of the connecting rod 55, as shown in FIG. 8. While the magnetic plate 77 is being attracted by the electric magnet 78, the bayonet 53 is to be synchronously moved off the locking groove 20. The compression spring 23 in the chamber 10 of the lock core base 1 is to elastically push the button 2 out as soon as the bayonet 53 moves away the locking groove 20 completely, spontaneously enabling the dead bolt member 22 to move away from the hole 75 of the dead bolt 74, keeping the dead bolt 74 unrestricted. And, by means of the control mechanism 73 installed in the control box 72, the dead bolt 74 is pulled back in the control box 72, then the door lock 70 is unlocked. With the lock core of the invention hidden in the door lock and unlocked without a key, a thief cannot easily break it, too.

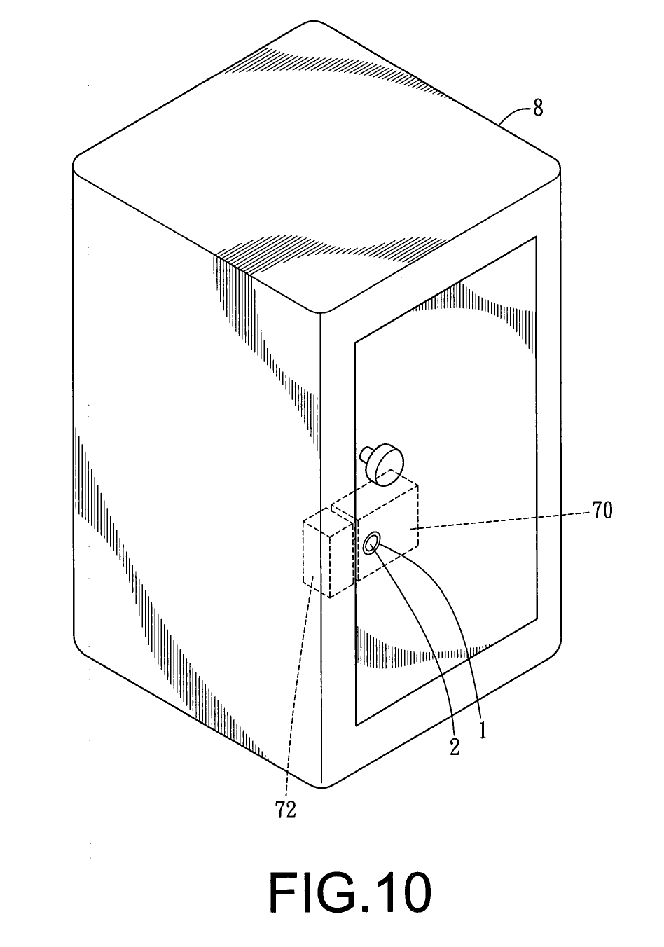

In addition, as shown in FIG. 10, the invention can be applied in a safe deposit 8, installed and operated the same way as the previous embodiment is.

While the preferred embodiment of the invention has been described above, it will be recognized and understood that various modifications may be made therein and the appended claims are intended to cover all such modifications that may fall within the spirit and scope of the invention.

What is claimed is:

1. A lock core comprising:
a lock core base provided with a chamber, a through hole bored in its one end to communicate with said chamber, an annular blocking surface formed at a boundary between said chamber and said through hole, and a threaded hole bored in its annular wall to communicate with said chamber;
a button installed in said lock core base and provided with a locking groove, a dead bolt member formed at its one end;
a compression spring mounted around said dead bolt and installed in said chamber;
a cover installed at one end of said lock core base and provided with a through hole for said dead bolt member of said button to pass through;
a connecting member installed in an annular wall of said lock core base and provided with a through hole;
a bayonet base connected with said connecting member and provided with a chamber, a through hole bored in its one end to communicate with said chamber;
a bayonet inserted in said bayonet base and having a blocking flange connected with a connecting rod; and
a compression spring mounted around said connecting rod and installed in said chamber of said bayonet base.

2. The lock core as claimed in claim 1, wherein female threads are formed at the other end of said chamber of said lock core base to engage with male threads provided in said cover.

3. The lock core as claimed in claim 1, wherein said lock core base is further provided with female threads formed in said chamber of said bayonet base, and said connecting member is provided with lower male threads for engaging with said threaded hole of said lock core base, and upper male threads for engaging with said female thread of said bayonet base.

4. A lock core as claimed in claim 1, wherein said button and said cover are respectively provided with an annular slot for fitting with each end of said compression spring in said chamber of said lock core base.
